(19) United States
(12) Patent Application Publication
(10) Pub. No.: US 2025/0148749 A1
(43) Pub. Date: May 8, 2025

(54) IMAGE PROCESSING DEVICE, IMAGE PROCESSING METHOD, AND PROGRAM

(71) Applicant: SONY GROUP CORPORATION, TOKYO (JP)

(72) Inventor: HIROYOSHI FUJII, TOKYO (JP)

(21) Appl. No.: 18/836,931

(22) PCT Filed: Feb. 6, 2023
(86) PCT No.: PCT/JP2023/003775

§ 371 Date: Aug. 8, 2024

(30) Foreign Application Priority Data
Feb. 17, 2022 (JP) 2022-023046

(51) Int. Cl. G06V 10/26; G06T 5/73; G06T 7/246; G06V 10/25

(52) U.S. Cl. CPC G06V 10/267; G06T 5/73; G06T 7/246; G06V 10/25; G06T 2207/20104; G06T 2207/20132; G06T 2207/20201

(57) ABSTRACT

This image processing device includes a composition determination unit that determines a composition in an image in accordance with a rule predetermined in a manner that depends on a subject, a region-of-interest determination unit that determines a region of interest in a cropped image corresponding to the composition in the image, and a motion information calculation unit that calculates motion information regarding motion of the subject predetermined in the region of interest.

### TECHNICAL FIELD

The present technology relates to an image processing device, an image processing method, and a program, and more particularly, to a technology to crop an image.

### BACKGROUND ART

When an image of a moving subject is captured by a camera, a subject portion in the captured image may suffer from blurring (so-called motion blurring). Therefore, there has been proposed an image processing device that executes a deblurring process on an entire image that suffers from blurring (see, for example, Patent Document 1).

### CITATION LIST

### Patent Document

Patent Document 1: Japanese Patent Application Laid-Open No. 2009-182576

### SUMMARY OF THE INVENTION

### Problems to be Solved by the Invention

Meanwhile, there is a case where a part of a captured image is cut off (so-called cropping). The cropped image, however, is a part of the captured image, so that even if the deblurring process as described above is executed on the entire image, there is a possibility that blurring of a subject in the cropped image portion cannot be necessarily removed.

The present technology therefore proposes a technology capable of providing a cropped image with blurring of a predetermined subject reduced.

### Solutions to Problems

An image processing device according to the present technology includes: a composition determination unit that determines a composition in an image in accordance with a rule predetermined in a manner that depends on a subject; a region-of-interest determination unit that determines a region of interest in a cropped image corresponding to the composition in the image; and a motion information calculation unit that calculates motion information regarding motion of the subject predetermined in the region of interest.

With this configuration, it is possible to reduce blurring of the predetermined subject and to make the other region blurred in accordance with the motion information regarding the predetermined subject for each cropped image.

### BRIEF DESCRIPTION OF DRAWINGS

FIG. 1 is a diagram schematically illustrating an image processing system.

FIG. 2 is a diagram illustrating a configuration of an image processing device.

FIG. 3 is a diagram illustrating a functional configuration of a CPU.

FIG. 4 is a flowchart illustrating a flow of image processing executed by the CPU.

FIG. 5 is a diagram illustrating a graphical user interface (GUI) for changing a method for determining a composition, the number of compositions, and a region of interest.

FIG. 6 is a diagram illustrating an example of a rule in accordance with which the composition, the number of compositions, and the region of interest are automatically determined.

FIG. 7 is a diagram illustrating a composition example focused on a person.

FIG. 8 is a diagram illustrating a composition example focused on an animal, a car, or a two-wheeled vehicle.

FIG. 9 is a diagram illustrating an example of how to determine a composition from an image.

FIG. 10 is a diagram illustrating an example of a cropped image subjected to a deblurring process.

FIG. 11 is a diagram illustrating an example of a GUI for allowing a user to select a composition.

### MODE FOR CARRYING OUT THE INVENTION

Hereinafter, an embodiment will be described in the following order.
<1. Image processing system>
<2. Configuration of image processing device 12 and overview of image processing>
<3. Specific example>
<4. Modification>
<5. Summary>
<6. Present technology>

Note that “image” in the present technology includes both a still image and a moving image. Furthermore, “image” refers not only to an image displayed on a display unit, but also to image data that is not displayed on the display unit.

Furthermore, “subject” refers not only to a target captured by a fixed camera 11, but also to a subject image appearing in the image. Furthermore, “subject” includes not only a person but also various objects such as an animal, a substance, and a character, and further includes a portion (part) of such an object.

Furthermore, “composition” refers to a partial region (range) in the image.

Furthermore, “cropped image” refers to an image portion corresponding to the composition in the entire image.

Furthermore, “region of interest” refers to a region corresponding to a predetermined subject determined in the cropped image.

Furthermore, “motion information” refers to information regarding motion (blurring) of the region of interest.

### 1. IMAGE PROCESSING SYSTEM

An image processing system to which the technology of the present technology can be applied will be described.

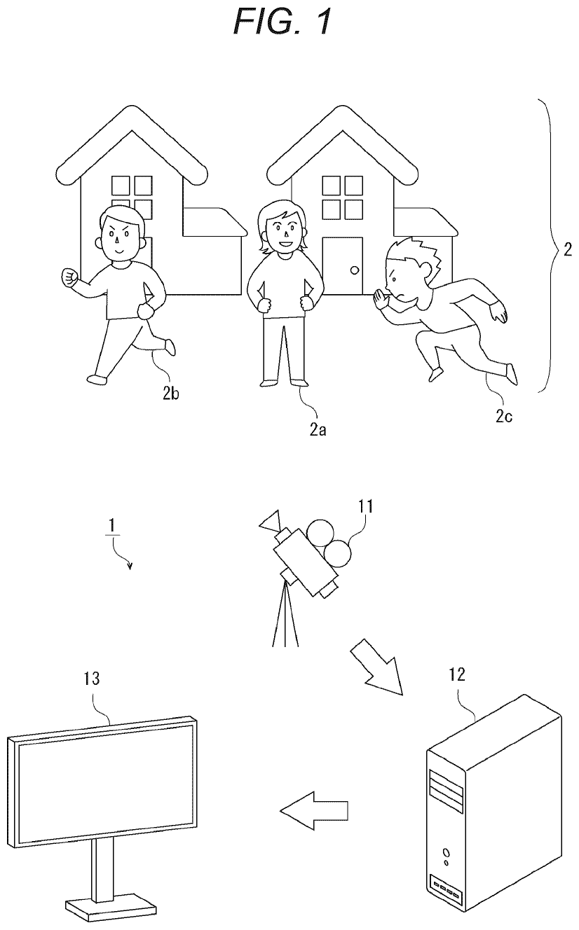

FIG. 1 is a diagram schematically illustrating an image processing system 1.

As illustrated in FIG. 1, the image processing system 1 includes the fixed camera 11, an image processing device 12, and a display device 13.

The fixed camera 11 is a camera that captures an image with both a position and an angle of view fixed, and captures a moving image in the present embodiment. In the example in FIG. 1, persons 2a to 2c are set as a subject 2, and the fixed camera 11 captures an image of the subject 2 including these persons 2a to 2c. Note that, in FIG. 1, a house illustrated behind the persons 2a to 2c serves as a background.

The image captured by the fixed camera 11 is input to the image processing device 12. The image processing device 12 cuts off (crops) a part of the image input from the fixed camera 11, removes (reduces) blurring of a portion corresponding to the predetermined subject 2 from the cropped image, and outputs the resultant image to the display device 13.

Note that details of the processing executed by the image processing device 12 will be described later.

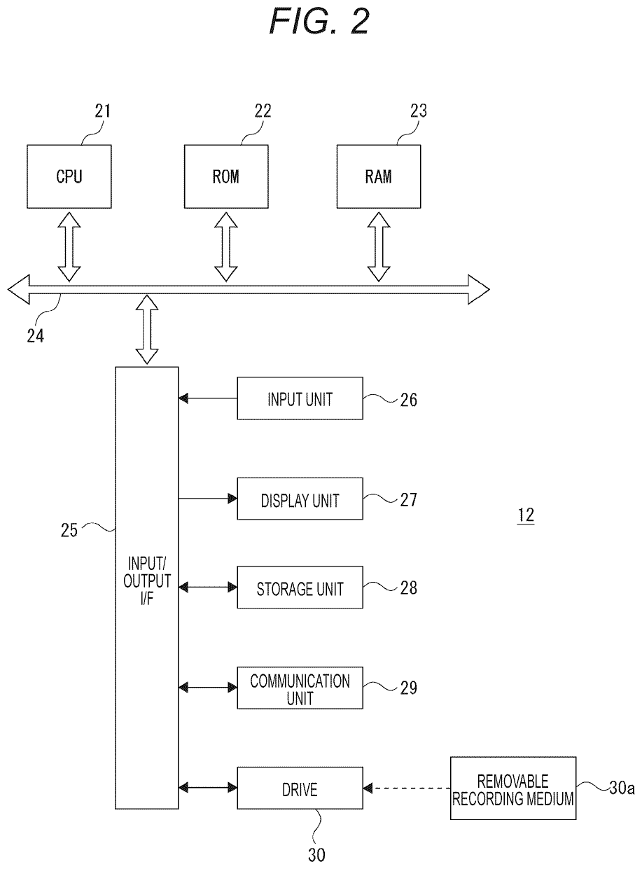

The display device 13 includes a display unit including a liquid crystal display (LCD), an organic light emitting diode (OLED) display, or the like, and displays the cropped image input from the image processing device 12. One or more display devices 13 are provided. Furthermore, the display device 13 may be a display unit 27 (see FIG. 2) of the image processing device 12.

In the image processing system 1, a pair of the fixed camera 11 and the image processing device 12, and a pair of the image processing device 12 and the display device 13 are each connected in a wired manner, in a wireless manner, or over the Internet.

For example, in the image processing system 1, it is assumed that the fixed camera 11 and the image processing device 12 are connected in a wired manner, the image processing device 12 and the display device 13 are connected over the Internet, and the cropped image captured by the fixed camera 11 and subjected to various processes by the image processing device 12 is distributed to a large number of display devices 13. Note that this usage example is merely an example, and other usage examples may be used.

### 2. CONFIGURATION OF IMAGE PROCESSING DEVICE 12 AND OVERVIEW OF IMAGE PROCESSING

FIG. 2 is a diagram illustrating a configuration of the image processing device 12.

The image processing device 12 is a device such as a computer device capable of executing information processing, particularly image processing. Specifically, possible examples of the image processing device 12 include a personal computer, a workstation, a portable terminal device such as a smartphone and a tablet, a video editing device, and the like. Furthermore, the image processing device 12 may be a computer device configured as a server device or an arithmetic device in cloud computing. Furthermore, the image processing device 12 may be provided in the fixed camera 11.

As illustrated in FIG. 2, the image processing device 12 includes a central processing unit (CPU) 21, a read only memory (ROM) 22, and a random access memory (RAM) 23.

The CPU 21 executes various processes in accordance with a program stored in the ROM 22 or a program loaded from a storage unit 28 into the RAM 23. Furthermore, the RAM 23 also stores, as appropriate, data and the like necessary for the CPU 21 to execute the various processes.

The CPU 21, the ROM 22, and the RAM 23 are interconnected via a bus 24. An input/output interface 25 is also connected to the bus 24.

An input unit 26 including an operation element or an operation device is connected to the input/output interface 25. For example, possible examples of the input unit 26 include various types of operation elements and operation devices such as a keyboard, a mouse, a key, a dial, a touch panel, a touch pad, a remote controller, and the like.

A user operation is detected by the input unit 26, and a signal corresponding to the input operation is interpreted by the CPU 21.

Furthermore, the display unit 27 including an LCD, an OLED display, or the like is integrally or separately connected to the input/output interface 25.

The display unit 27 can display various images, operation menus, icons, messages, and the like, that is, display as a graphical user interface (GUI), on a display screen on the basis of an instruction from the CPU 21.

Furthermore, the storage unit 28 including a hard disk drive (HDD), a solid-state memory, or the like and a communication unit 29 are connected to the input/output interface 25. The storage unit 28 can store various pieces of data and programs.

The communication unit 29 executes communication processing via a transmission path such as the Internet, and communicates with various devices such as the fixed camera 11 and the display device 13 via wired communication, wireless communication, bus communication, or the like.

Furthermore, a drive 30 is also connected to the input/output interface 25 as necessary, and a removable recording medium 30a such as a magnetic disk, an optical disc, a magneto-optical disk, or a semiconductor memory is mounted as appropriate.

It is possible to read images, various computer programs, and the like from the removable recording medium 30a with the drive 30. The read data is stored in the storage unit 28, and images and audio included in the data are output by the display unit 27. Furthermore, the computer programs and the like read from the removable recording medium 30a are installed in the storage unit 28, as necessary.

In the image processing device 12, for example, software for the processing of the present embodiment can be installed via network communication established by the communication unit 29 or the removable recording medium 30a. Alternatively, the software may be stored in advance in the ROM 22, the storage unit 28, or the like.

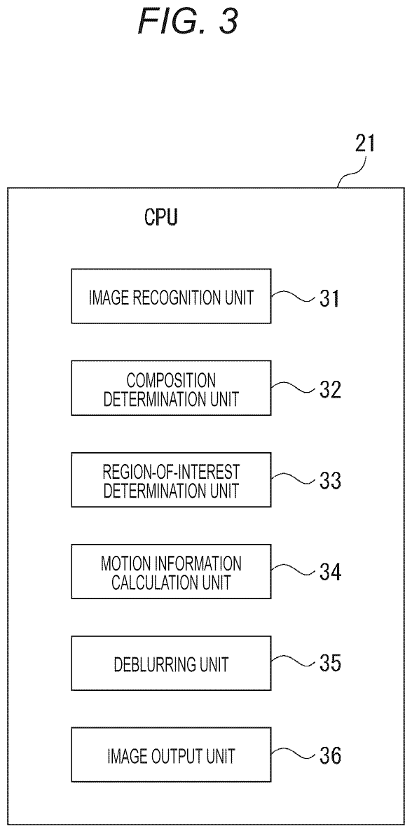

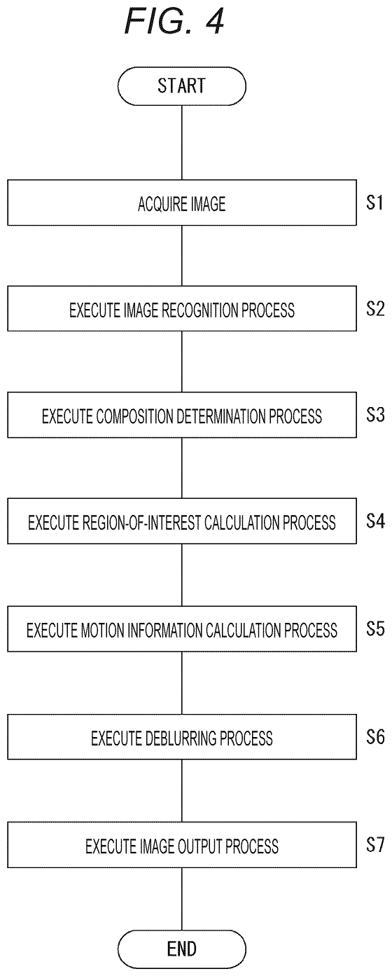

FIG. 3 is a diagram illustrating a functional configuration of the CPU 21. FIG. 4 is a flowchart illustrating a flow of image processing executed by the CPU 21. Note that the image processing illustrated in FIG. 4 is executed for each image of one frame. Note that this image processing need not necessarily be executed for every frame, and may be executed as appropriate for, for example, every several frames.

As illustrated in FIG. 3, the CPU 21 functions as an image recognition unit 31, a composition determination unit 32, a region-of-interest determination unit 33, a motion information calculation unit 34, a deblurring unit 35, and an image output unit 36.

As illustrated in FIG. 4, when acquiring an image (image of one frame) from the fixed camera 11 in step S1, the image recognition unit 31 executes an image recognition process on the image in step S2. The image recognition process is a process of detecting and recognizing the subject 2 from the image, and includes various processes such as object detection, object recognition, individual recognition, skeleton detection, saliency recognition, motion recognition, text recognition, pupil detection, face detection, emotion recognition, and speaker recognition. Such processes are executed using a known technology, so that no description will be given herein of each process. Furthermore, it is only required that one or more of the processes be executed as appropriate, and it is not necessary to execute all of the processes.

For example, the image recognition unit 31 executes skeleton detection on the image, and detects joint positions and bones of a person in the image. Furthermore, the image recognition unit 31 executes face detection on the image, and associates the skeleton detection result with the detected face region. Furthermore, the image recognition unit 31 executes individual identification for identifying an individual using the face detection result, and associates the identified individual with the skeleton detection result.

After the end of the image recognition process, the composition determination unit 32 executes, on the image acquired from the fixed camera 11, a composition determination process of determining a composition in accordance with a rule predetermined in a manner that depends on the subject 2 in step S3. In the composition determination process, the composition determination unit 32 may automatically determine the composition on the basis of the result of the image recognition process, or may determine the composition in accordance with a rule specified by the user.

Note that “automatically” means that the CPU 21 makes a determination in accordance with a predetermined rule even if the user does not specify a rule, and the same applies to the following.

Furthermore, in the composition determination process, the composition determination unit 32 may automatically determine the number of compositions on the basis of the result of the image recognition process, or may determine the number of compositions specified by the user. Therefore, in the composition determination process, one or more compositions are determined for one image.

Note that an image portion corresponding to the composition determined by the composition determination process is output to the display device 13 as the cropped image, so that it can be said that the composition determination unit 32 determines the cropped image from the image acquired from the fixed camera 11.

After the end of the composition determination process, the region-of-interest determination unit 33 executes, in step S4, a region-of-interest determination process of determining a subject 2 region to be subjected to deblurring as the region of interest for each composition determined in step S3, that is, for each cropped image.

In the region-of-interest determination process, the region-of-interest determination unit 33 may automatically determine the region of interest in accordance with the rule used when the composition is determined, or may determine the region of interest in accordance with a rule specified by the user.

After the end of the region-of-interest determination process, the motion information calculation unit 34 executes, in step S5, a motion information calculation process of calculating motion information regarding the region of interest (information regarding blurring) for each composition determined in step S3, that is, for each cropped image.

Here, since the position and angle of view of the fixed camera 11 are fixed, blurring does not occur in the image in a case where the subject 2 is not moving. On the other hand, in a case where the subject 2 is moving, blurring occurs in the image in a manner that depends on the speed and trajectory of direction of the moving subject 2.

Therefore, the motion information calculation unit 34 calculates, for example, a point spread function (PSF) as the motion information regarding the region of interest.

The PSF is a function that defines a degree of spread of blurring that occurs in a manner that depends on the speed and direction of the moving subject 2. It is therefore possible to calculate, by calculating the PSF by the motion information calculation process, a degree of blurring occurring in the region of interest.

Note that the PSF can be calculated using a known method, so that no detailed description of the PSF will be given herein.

After the end of the motion information calculation process, the deblurring unit 35 executes, in step S6, deblurring process of removing (reducing) blurring for each composition, that is, for each cropped image. In the deblurring process, deconvolution using the PSF calculated in step S6 is executed on the entire cropped image. With this configuration, in the cropped image, the blurring of the region of interest (subject 2) is removed, and blurring occurs in regions (for example, the background) other than the region of interest.

As described above, the CPU 21 can generate, by generating the cropped image in which the blurring of the subject 2 is removed, and blurring occurs in the background, a cropped image as if the moving subject 2 is tracked and imaged by a pan-tilt-zoom camera (PTZ camera) from the image acquired from fixed camera 11.

Then, in step S7, the image output unit 36 outputs, to the display device 13, the cropped image in which the blurring of the subject 2 is removed, and blurring occurs in the background.

Hereinafter, the composition determination process and the region-of-interest determination process will be mainly described in detail with a specific example.

### 3. SPECIFIC EXAMPLE

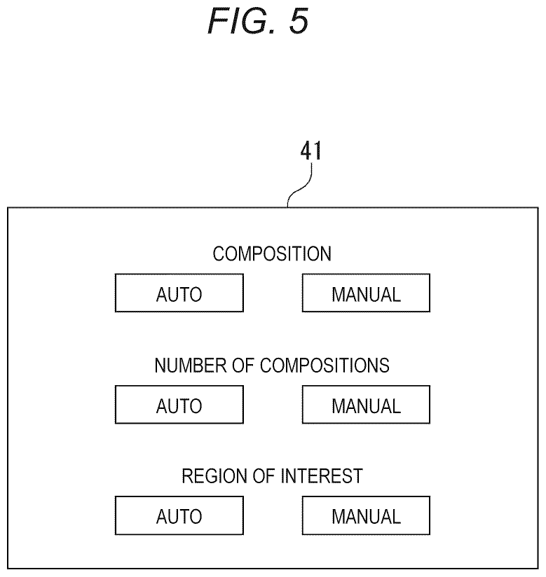

FIG. 5 is a diagram illustrating a GUI for changing a method for determining the composition, the number of compositions, and the region of interest. In the composition determination process and the region-of-interest determination process, it is possible to switch between automatic determination of the composition, the number of compositions, and the region of interest based on the result of the image recognition process and determination of the composition, the number of compositions, and the region of interest based on a rule specified by the user.

For example, before the start of the above-described image processing, the CPU 21 displays a GUI 41 as illustrated in FIG. 5 on the display unit 27 to allow the user to select which determination method to use. Note that, in FIG. 5, “auto” is an icon for selecting automatic determination, and “manual” is an icon for selecting that the user specifies a rule.

Then, when “auto” or “manual” is selected for each of the composition, the number of compositions, and the region of interest in response to the operation of the input unit 26, the CPU 21 determines the composition, the number of compositions, and the region of interest by the determination method selected for each. Note that, in a case where “manual” is selected, a GUI (not illustrated) for inputting a rule of a determination method is displayed on the display unit 27, and the user can specify each rule by operating the input unit 26.

### 3-1. Specific Example 1

Next, a composition determination process and a region-of-interest determination process in a case where “auto” is selected for the composition, the number of compositions, and the region of interest will be described.

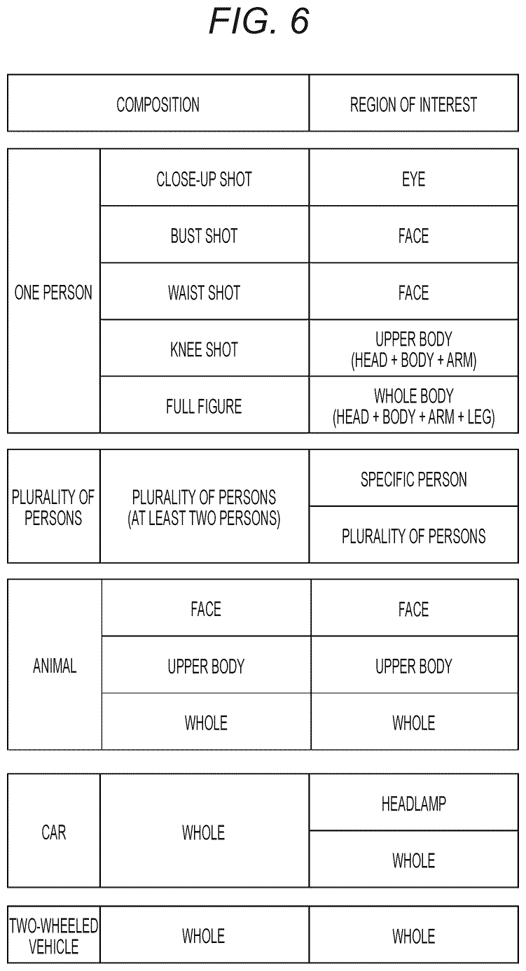

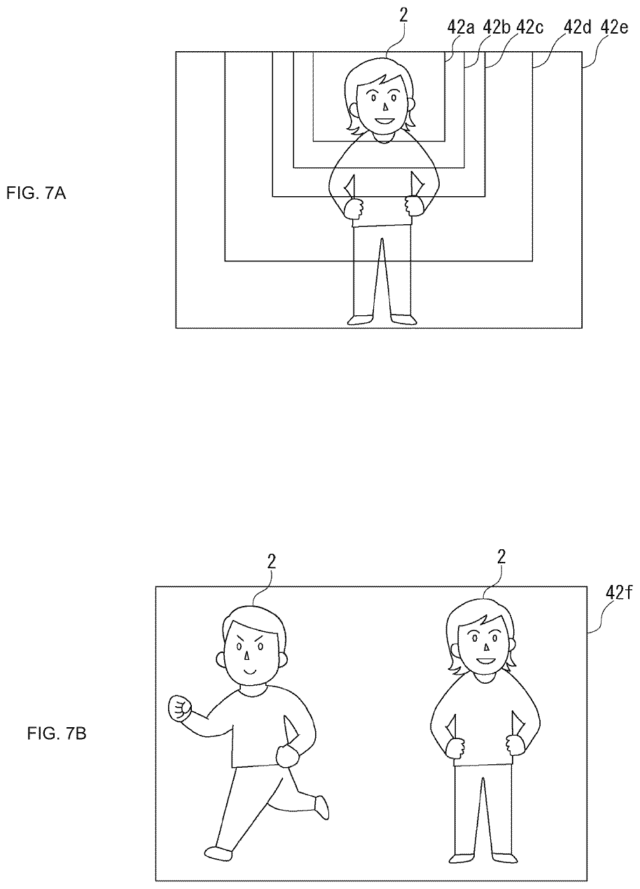

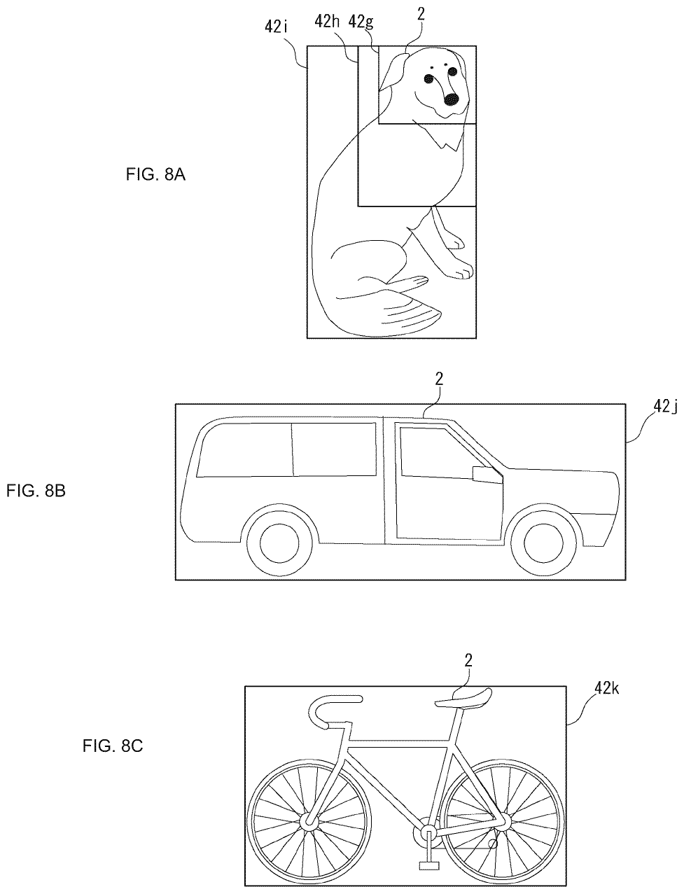

FIG. 6 is a diagram illustrating an example of a rule in accordance with which the composition, the number of compositions, and the region of interest are automatically determined. FIG. 7 is a diagram illustrating a composition example focused on a person. FIG. 8 is a diagram illustrating a composition example focused on an animal, a car, or a two-wheeled vehicle.

In a case where “auto” is selected, the composition determination unit 32 determines the composition in accordance with a predetermined rule as illustrated in FIG. 6. Specifically, as illustrated in FIGS. 6 and 7(a), a composition focused on one person includes a composition 42a of a close-up shot (face), a composition 42b of a bust shot (above the chest), a composition 42c of a waist shot (upper body), a composition 42d of a knee shot (above the knee), and a composition 42e of a full figure (whole body).

Furthermore, as illustrated in FIGS. 6 and 7(b), a composition focused on a plurality of persons includes a composition 42f covering the whole bodies of the plurality of persons. Furthermore, as illustrated in FIGS. 6 and 8(a), a composition focused on an animal (a dog in the drawing) includes a composition 42g focused on the face of the animal, a composition 42h focused on the upper body of the animal, and a composition 42i focused on the whole of the animal. Furthermore, as illustrated in FIGS. 6, 8(b), and 8(c), a composition focused on a car or a two-wheeled vehicle includes a composition 42j focused on the whole of the car and a composition 42k focused on the whole of the two-wheeled vehicle.

As described above, in a case where the composition and the number of compositions are automatically determined, the composition determination unit 32 may determine all the possible compositions on the basis of the above-described rule in response to the result of the image recognition process executed by image recognition unit 31, or may select and determine, at random, a composition from among the possible compositions, or further alternatively, may determine, for example, in a case where the subject 2 is one person, one of the compositions of the close-up shot to the full figure.

Furthermore, the composition determination unit 32 may first determine the number of compositions at random, for example, and determine the composition on the basis of the above-described rule so as to satisfy the determined number of compositions.

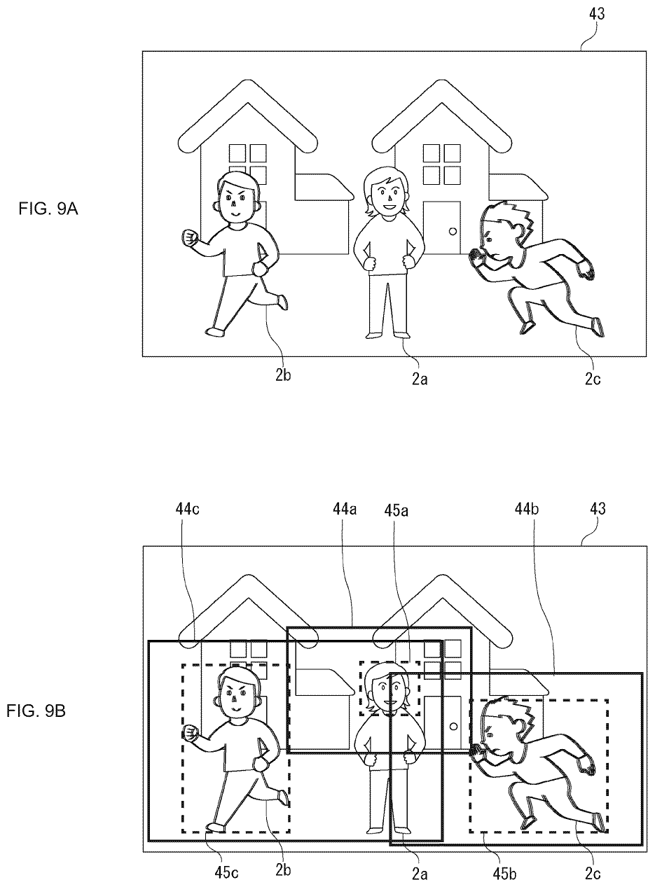

FIG. 9 is a diagram illustrating an example of how to determine a composition from an image. For example, in a case where the subject 2 illustrated in FIG. 1 is imaged by the fixed camera 11, an image 43 as illustrated in FIG. 9(a) is acquired by the image processing device 12. Note that, in this example, it is assumed that the person 2a is not moving, and the persons 2b and 2c are moving. Furthermore, it is assumed that the person 2c is moving faster than the person 2b.

In such a case, in the image 43 captured by the fixed camera 11, no blurring occurs in the person 2a and the background, and blurring occurs in the persons 2b and 2c. Furthermore, in the image 43, blurring occurring in the person 2c is larger than blurring occurring in the person 2b.

It is assumed that the image recognition unit 31 executes the image recognition process on such an image 43, and the persons 2a to 2c are identified as a result of the image recognition process, for example. Here, the persons 2a to 2c are recognized as persons, and parts of each person such as a skeleton, a face, and a pupil are also detected.

Then, the composition determination unit 32 determines compositions 44a to 44c as illustrated in FIG. 9(b), for example, in accordance with the result of the image recognition process and the composition rule illustrated in FIG. 6. The composition 44a is determined as a composition of a waist shot of the person 2a. The composition 44b is determined as a composition of a full figure of the person 2c. The composition 44c is determined as a composition covering the whole bodies of the persons 2a and 2b. Furthermore, the number of compositions is determined to be three.

When the composition is determined as described above, the region-of-interest determination unit 33 determines the region of interest in accordance with the rule as illustrated in FIG. 6. Specifically, the eyes of the person are determined as the region of interest in the composition 42a of the close-up shot, the face of the person is determined as the region of interest in the composition 42b of the bust shot, the face of the person is determined as the region of interest in the composition 42c of the waist shot, the upper body is determined as the region of interest in the composition 42d of the knee shot, and the whole body is determined as the region of interest in the composition 42e of the full figure.

Furthermore, in the composition 42f covering the whole bodies of the plurality of persons, a specific person or a plurality of persons is determined as the region of interest. Furthermore, in the composition 42j focused on the whole of the car, the headlamp or the whole of the car is determined as the region of interest. Furthermore, in the composition 42k focused on the whole of the two-wheeled vehicle, the whole of the two-wheeled vehicle is determined as the region of interest.

Therefore, in the example illustrated in FIG. 9(b), the face of the person 2a is determined as a region of interest 45a in the composition 44a, the whole body of the person 2c is determined as a region of interest 45b in the composition 44b, and the whole body of the person 2b is determined as a region of interest 45c in the composition 44c, for example.

When the region of interest is determined for each composition, the motion information calculation unit 34 calculates a PSF of the region of interest for each composition.

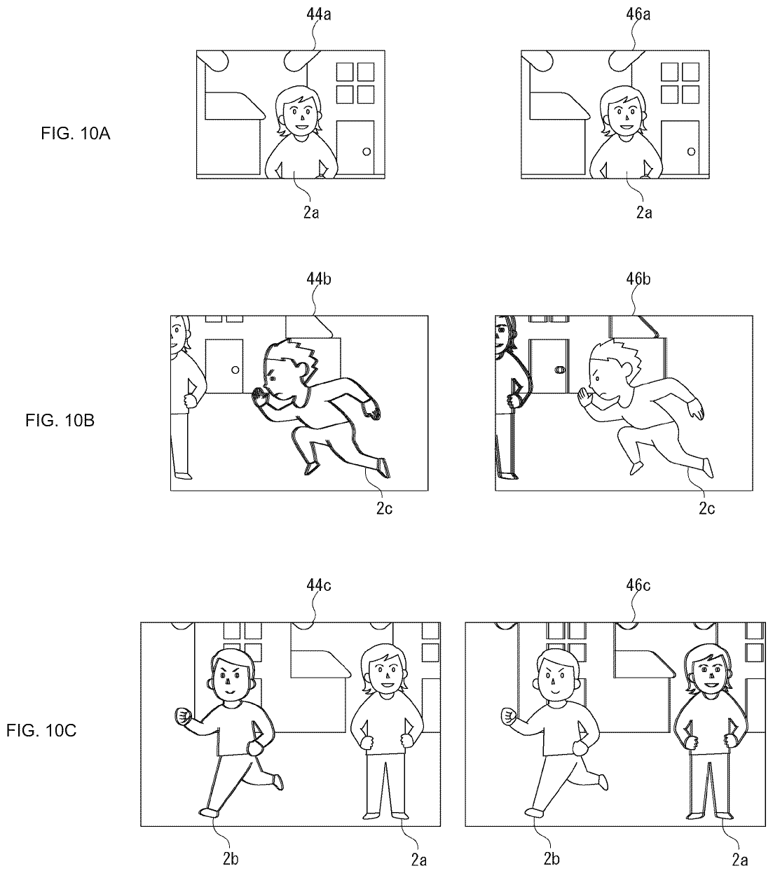

FIG. 10 is a diagram illustrating an example of a cropped image subjected to the deblurring process. When the PSF of the region of interest is calculated for each composition, the deblurring unit 35 executes deconvolution using the calculated PSF on the whole of the cropped image (the whole of the composition).

For example, as illustrated in FIG. 10(a), in the composition 44a, the person 2a is not moving from the beginning, and no blurring has occurred in the cropped image corresponding to the composition 44a, so that, also in a cropped image 46a generated as a result of executing the deblurring process, no blurring has occurred in the person 2a and the background.

Furthermore, in the composition 44b, the person 2c is moving, and blurring has occurred in the whole body of the person 2c, so that, in a cropped image 46b generated as a result of executing the deblurring process, the blurring of person 2c determined as the region of interest 45b is removed, and blurring occurs in the background (and the person 2a).

Furthermore, in the composition 44c, the person 2b is moving, and blurring has occurred in the whole body of the person 2b, so that, in a cropped image 46c generated as a result of executing the deblurring process, the blurring of person 2b determined as the region of interest 45c is removed, and blurring occurs in the person 2a and the background.

As described above, in a case where “auto” is selected for the composition, the number of compositions, and the region of interest, the series of image processing is automatically executed by the CPU 21 without user operation, and as a result, one or a plurality of cropped images in which the blurring of the predetermined subject 2 has been removed (reduced), and blurring has occurred (increased) in the background (region other than the predetermined subject 2) is generated.

### 3-2. Specific Example 2

Next, a composition determination process and a region-of-interest determination process in a case where “manual” is selected for the composition, the number of compositions, and the region of interest will be described.

In a case where “manual” is selected, the composition determination unit 32 determines the composition and the number of compositions in accordance with the rule specified in advance by the user using the input unit 26. As the rule specified by the user, it is possible to specify various rules such as a composition focused on a specific person (individual) or a composition focused on a person closest to a specific object among a plurality of persons.

Note that, in a case where the number of compositions specified by the user cannot be determined in accordance with the rule specified by the user, the composition determination unit 32 may determine the remaining compositions in accordance with the predetermined rule as described in the case of “auto”.

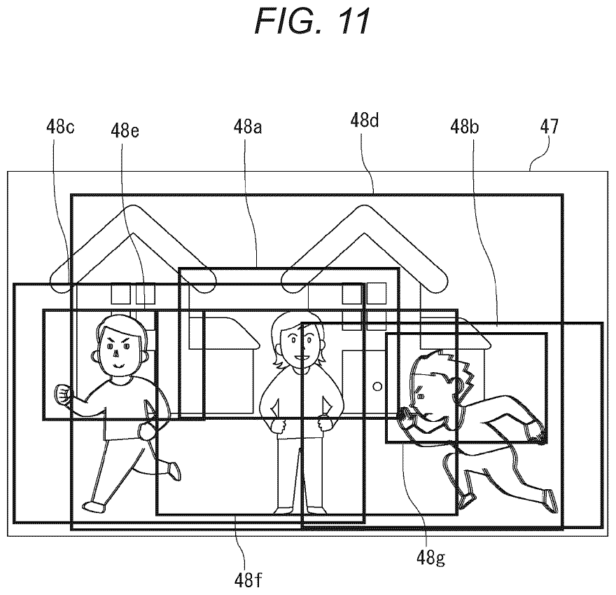

FIG. 11 is a diagram illustrating an example of a GUI for allowing the user to select a composition. Furthermore, in a case where “manual” is selected, it is conceivable that the user causes the composition determination unit 32 to extract candidates for the composition in accordance with the rule described for “auto”, and selects one of the extracted candidates to specify the composition to be determined.

In this case, as illustrated in FIG. 11, the composition determination unit 32 determines a plurality of candidates (here, candidates 48a to 48g) for the composition from the image 43 in accordance with the rule illustrated in FIG. 6, and displays the determined candidates on the display unit 27 as a selectable GUI 47.

Then, when the user selects a candidate using the input unit 26, the composition determination unit 32 determines (finally determines) the composition of the candidate selected by the user as the official composition.

With this configuration, the user only needs to select a desired composition from the candidates for the composition, and can determine an intended composition rather than “auto”.

Furthermore, the region-of-interest determination unit 33 determines the region of interest for each composition in accordance with the rule specified by the user in advance using the input unit 26. Under the rule specified by the user, it is possible to specify only the face of a specific person as the region of interest, and specify the upper bodies of the other persons as the region of interest.

Note that, in a case where the region of interest cannot be determined under the rule specified by the user, the region-of-interest determination unit 33 may determine the region of interest in accordance with the predetermined rule as described in the case of “auto”.

Furthermore, in a case where “manual” is selected, it is conceivable that the user causes the region-of-interest determination unit 33 to extract candidates for the region of interest in accordance with the rule described for “auto”, and selects one of the extracted candidates to specify the region of interest to be determined, in a manner similar to the case where candidates for the composition are displayed.

In this case, the region-of-interest determination unit 33 determines the region of interest for each composition in accordance with the rule illustrated in FIG. 6. Then, in a case where a plurality of regions of interest can be determined for one composition, candidates for the plurality of regions of interest are displayed on the display unit 27 as a selectable GUI.

Then, when the user selects a candidate using the input unit 26, the region-of-interest determination unit 33 determines (finally determines) the region of interest of the candidate selected by the user as the official region of interest.

With this configuration, the user only needs to select a desired region of interest from the candidates for the region of interest, and can determine a region of interest that reflects the intent of the user more accurately than “auto”.

### 4. MODIFICATION

Note that the embodiment is not limited to the specific examples described above, and configurations as various modifications may be adopted.

For example, in the above-described embodiment, the image processing device 12 acquires an image from the fixed camera 11. Note that the image processing device 12 may acquire an image from the PTZ camera. The PTZ camera is capable of imaging the specific subject 2 while following the specific subject 2; however, for example, in a case where the specific subject 2 moves quickly, and the PTZ camera cannot follow the subject 2, it is possible to execute the image processing of the embodiment to remove the blurring of the subject 2.

Furthermore, in the above-described embodiment, in a case where the knee shot is determined as the composition, the region-of-interest determination unit 33 automatically determines the upper body as the region of interest in accordance with the composition (in the case of “auto”). Note that it is conceivable that the head, body, and arms of the upper body move separately. As described above, in a case where it is assumed that a plurality of subjects 2 (each part, a plurality of persons, or the like) moves separately, the region-of-interest determination unit 33 may determine each of the plurality of subjects 2 (a head, a body, and arms, a plurality of persons, or the like) as the region of interest.

Then, the motion information calculation unit 34 may calculate a PSF of each of the plurality of regions of interest, and set a value obtained by averaging the calculated PSFs as the PSF (motion information) of the composition. With this configuration, it is possible to remove (reduce) the blurring on the basis of the average motion information regarding the subjects 2 moving differently.

Furthermore, the motion information calculation unit 34 may calculate PSFs of the plurality of regions of interest, and set a value obtained by giving predetermined weights to and adding up the calculated PSFs as the PSF of (motion information regarding) the composition.

With this configuration, it is possible to remove (reduce) blurring by, for example, giving, to a PSF of a subject 2 with a large area, a weight larger than weights given to PSFs of the other subjects 2 to increase the influence of the subject 2 larger in area than the other subjects 2.

Furthermore, for example, it is also possible to remove (reduce) blurring by giving, to a PSF of a subject 2 recognized as a speaker, a weight larger than weights given to PSFs of the other subjects 2 to increase the influence of the subject 2 recognized as the speaker.

Furthermore, for example, it is also possible to remove (reduce) blurring by giving a larger weight to a PSF of a subject 2 recognized as a specific person specified as an important person by the user to increase the influence of the subject 2.

Furthermore, for example, in a case where the head, body, and arms of the same person are determined as a plurality of regions of interest, it is also possible to remove (reduce) blurring by giving a weight to an important part (subject 2) such that the weight increases with the degree of importance such as 70% for the head, 20% for the body, and 10% for the arms to increase the influence of the more important part.

Furthermore, in a case where the fixed camera 11 can record both video and voices simultaneously, a recognition process may be executed on the voices recorded by the CPU 21, and the voice recognition result may be used for calculation of the composition and the region of interest in a manner similar to the image recognition result. With this configuration, it is possible to remove (reduce) blurring by, for example, identifying a speaker on the basis of the voice recognition result and giving, to a PSF of the identified speaker, a weight larger than weights given to PSFs of the other subjects 2 to increase the influence of the identified speaker.

Furthermore, for example, in a case where an utterance of a specific keyword (person name, object name, or the like) is recognized, it is possible to calculate a composition corresponding to the keyword preferentially. Specifically, the composition may be determined so as to cover the subject 2 corresponding to the recognized keyword, or the composition may be included so as to cover a subject 2 corresponding to a keyword that has been recognized more than a predetermined number among recognized keywords. Furthermore, the weight may be given to the PSF of the subject 2 corresponding to each recognized keyword such that the weight increases in descending order of the number of times of recognition among the recognized keywords.

### 5. SUMMARY

According to the above-described embodiment, the following effects can be obtained.

The image processing device 12 of the embodiment includes the composition determination unit 32 that determines a composition in an image in accordance with a rule predetermined in a manner that depends on a subject 2, the region-of-interest determination unit 33 that determines a region of interest in a cropped image corresponding to the composition in the image, and the motion information calculation unit 34 that calculates motion information regarding motion of the subject 2 predetermined in the region of interest.

With this configuration, the image processing device 12 can reduce blurring in accordance with the motion information regarding the predetermined subject 2 for each cropped image.

The image processing device 12 therefore can provide a cropped image with blurring of the predetermined subject 2 reduced.

The image processing device 12 further includes the deblurring unit 35 that executes a deblurring process on all of the cropped image in accordance with the motion information.

With this configuration, it is possible to provide a cropped image in which blurring of the predetermined subject 2 is reduced, and blurring occurs in the background as if the PTZ camera images the predetermined subject 2 while following the predetermined subject 2.

Here, the PTZ camera can normally capture only one image, but the image processing device 12 can provide a plurality of cropped images at a time by setting a plurality of compositions. This eliminates the need for providing a plurality of PTZ cameras, so that it is possible to reduce the cost of the image processing system 1 as a whole.

Furthermore, in a case where the subject 2 in the cropped image is moving, the deblurring unit 35 executes the deblurring process on all of the cropped image in accordance with the motion information to reduce blurring of the subject 2 in the cropped image and increase blurring of a region other than the subject 2.

With this configuration, it is possible to provide, in a case where the subject 2 is moving, a cropped image as if the subject 2 is imaged while following the subject 2.

The image output unit 36 that outputs the cropped image subjected to the deblurring process is further included.

With this configuration, it is possible to display the cropped image on the external display device 13 and to display the cropped image simultaneously on a plurality of the display devices 13, for example.

Furthermore, the region-of-interest determination unit 33 determines the region of interest in accordance with the rule used when the composition is determined.

With this configuration, it is possible to determine the optimum subject 2 as the region of interest for each composition, so that blurring of the subject 2 can be accurately reduced.

Furthermore, in a case where there is a plurality of the subjects 2 that moves differently in the cropped image, the region-of-interest determination unit 33 determines each of the plurality of subjects 2 as the region of interest.

With this configuration, it is possible to reduce blurring in accordance with the parts that move differently.

Furthermore, in a case where a plurality of the regions of interest is determined in the cropped image, the motion information calculation unit 34 calculates a value obtained by averaging pieces of the motion information regarding the plurality of regions of interest as the motion information regarding the cropped image.

With this configuration, it is possible to reduce, in a case where the subject 2 moves differently for each part or in a case where the plurality of subjects 2 moves differently, blurring in accordance with the average motion of the subjects.

Furthermore, in a case where a plurality of the regions of interest is determined in the cropped image, the motion information calculation unit 34 calculates a value obtained by giving predetermined weights to and adding up pieces of the motion information regarding the plurality of regions of interest as the motion information regarding the cropped image.

With this configuration, it is possible to reduce, in a case where the subject 2 moves differently for each part or in a case where the plurality of subjects 2 moves differently, blurring optimally by adjusting the weights.

The image processing device 12 further includes the image recognition unit 31 that executes an image recognition process of recognizing the subject 2 from the image.

This configuration eliminates the need for, for example, manually extracting the subject 2, and it is possible to determine the composition and the region of interest with ease.

Furthermore, the composition determination unit 32 determines the composition on the basis of a result of the image recognition process.

With this configuration, when the image is acquired, the composition is automatically determined, so that it is possible to reduce the burden on the user.

Furthermore, the composition determination unit 32 determines the number of the compositions on the basis of the result of the image recognition process.

With this configuration, when the image is acquired, the number of compositions is automatically determined, so that it is possible to reduce the burden on the user.

Furthermore, the composition determination unit 32 determines the composition on the basis of a rule specified by a user.

With this configuration, it is possible to provide a cropped image capturing a subject 2 intended by the user.

Furthermore, the composition determination unit 32 determines the number of the compositions specified by the user.

With this configuration, it is possible to provide the number of cropped images intended by the user.

Furthermore, the composition determination unit 32 is capable of switching between determination of the composition based on the result of the image recognition process and determination of the composition based on the rule specified by the user.

With this configuration, for example, in a case where there is no subject 2 that the user pays attention to, it is possible to provide a cropped image based on the composition automatically determined, and in a case where there is a subject 2 that the user pays attention to, it is possible to provide a cropped image based on the composition specified by the user.

It is therefore possible to reduce the burden on the user and provide a cropped image reflecting the intent of the user.

Furthermore, the composition determination unit 32 determines a plurality of candidates for the composition in the image, causes the user to select one of the plurality of candidates determined, and finally determines the composition selected.

With this configuration, it is possible to cause the user to select the most desired composition from, for example, a list of candidates for the composition automatically given, and it is possible to further reduce the burden on the user and provide a cropped image in line with the intent of the user.

Furthermore, the region-of-interest determination unit 33 determines a plurality of candidates for the region of interest in the cropped image, causes the user to select one of a plurality of the regions of interest determined, and finally determines the region of interest selected.

With this configuration, it is possible to cause the user to select the most desired region of interest from, for example, a list of candidates for the region of interest automatically given, and it is possible to further reduce the burden on the user and provide a cropped image in line with the intent of the user.

Furthermore, the image is captured by the fixed camera 11.

With this configuration, regarding the image captured by the fixed camera 11 whose position and angle of view are fixed, it is possible to provide a cropped image in which blurring of the predetermined subject 2 is reduced and blurring occurs in the background as if the PTZ camera images the predetermined subject 2 while following the predetermined subject 2.

Furthermore, the image is captured by the PTZ camera.

With this configuration, even in a case where the PTZ camera cannot follow the motion of the subject 2, it is possible to reduce the blurring of the predetermined subject 2 and to provide a cropped image in which blurring occurs in the background.

Furthermore, an image processing method includes determining a composition in an image in accordance with a rule predetermined in a manner that depends on a subject 2, determining a region of interest in a cropped image corresponding to the composition in the image, and calculating motion information regarding motion of the subject 2 predetermined in the region of interest.

Furthermore, a program causes a computer to execute processing, the processing including determining a composition in an image in accordance with a rule predetermined in a manner that depends on a subject 2, determining a region of interest in a cropped image corresponding to the composition in the image, and calculating motion information regarding motion of the subject 2 predetermined in the region of interest.

The program of the embodiment is, for example, a program for causing a processor such as a CPU or a DSP, or a device including the processor to execute the image processing described above.

Such a program can be recorded in advance in an HDD as a recording medium built in a device such as a computer device, a ROM in a microcomputer having a CPU, or the like. Furthermore, such a program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program may be installed from the removable recording medium into a personal computer or the like, or may be downloaded from a download site over a network such as a local area network (LAN) or the Internet.

Note that the effects described in the present description are merely examples and are not limited, and other effects may be provided.

### 6. PRESENT TECHNOLOGY

Note that, the present technology may also have the following configurations.
(1)

An image processing device including:
a composition determination unit that determines a composition in an image in accordance with a rule predetermined in a manner that depends on a subject;
a region-of-interest determination unit that determines a region of interest in a cropped image corresponding to the composition in the image; and
a motion information calculation unit that calculates motion information regarding motion of the subject predetermined in the region of interest.
(2)

The image processing device according to (1), further including a deblurring unit that executes a deblurring process on all of the cropped image in accordance with the motion information.
(3)

The image processing device according to (2), in which
in a case where the subject in the cropped image is moving, the deblurring unit executes the deblurring process on all of the cropped image in accordance with the motion information to reduce blurring of the subject in the cropped image and increase blurring of a region other than the subject.
(4)

The image processing device according to (2) or (3), further including an image output unit that outputs the cropped image subjected to the deblurring process.
(5)

The image processing device according to any one of (1) to (4), in which
the region-of-interest determination unit determines the region of interest in accordance with the rule used when the composition is determined.
(6)

The image processing device according to any one of (1) to (5), in which
in a case where there is a plurality of the subjects that moves differently in the cropped image, the region-of-interest determination unit determines each of a plurality of the subjects as the region of interest.
(7)

The image processing device according to (6), in which
in a case where a plurality of the regions of interest is determined in the cropped image, the motion information calculation unit calculates a value obtained by averaging pieces of the motion information regarding a plurality of the regions of interest as the motion information regarding the cropped image.
(8)

The image processing device according to (6), in which
in a case where a plurality of the regions of interest is determined in the cropped image, the motion information calculation unit calculates a value obtained by giving predetermined weights to and adding up pieces of the motion information regarding a plurality of the regions of interest as the motion information regarding the cropped image.
(9)

The image processing device according to any one of (1) to (8), further including an image recognition unit that executes an image recognition process of recognizing the subject from the image.
(10)

The image processing device according to (9), in which
the composition determination unit determines the composition on the basis of a result of the image recognition process.
(11)

The image processing device according to (9), in which
the composition determination unit determines the number of the compositions on the basis of a result of the image recognition process.
(12)

The image processing device according to any one of (1) to (9), in which
the composition determination unit determines the composition on the basis of a rule specified by a user.
(13)

The image processing device according to any one of (1) to (9), or (12), in which
the composition determination unit determines the number of the compositions specified by a user.
(14)

The image processing device according to (9), in which
the composition determination unit is capable of switching between determination of the composition based on a result of the image recognition process and determination of the composition based on a rule specified by a user.
(15)

The image processing device according to any one of (1) to (14), in which
the composition determination unit determines a plurality of candidates for the composition in the image, causes a user to select one of the plurality of candidates determined, and finally determines the composition selected.
(16)

The image processing device according to any one of (1) to (15), in which
the region-of-interest determination unit determines a plurality of candidates for the region of interest in the cropped image, causes a user to select one of a plurality of the regions of interest determined, and finally determines the region of interest selected.
(17)

The image processing device according to any one of (1) to (16), in which
the image is captured by a fixed camera.
(18)

The image processing device according to any one of (1) to (16), in which
the image is captured by a PTZ camera.
(19)

An image processing method including:
determining a composition in an image in accordance with a rule predetermined in a manner that depends on a subject;
determining a region of interest in a cropped image corresponding to the composition in the image; and
calculating motion information regarding motion of the subject predetermined in the region of interest.
(20)

A program for causing a computer to execute processing, the processing including:
determining a composition in an image in accordance with a rule predetermined in a manner that depends on a subject;
determining a region of interest in a cropped image corresponding to the composition in the image; and
calculating motion information regarding motion of the subject predetermined in the region of interest.

### REFERENCE SIGNS LIST

1 Image processing system
11 Fixed camera
12 Image processing device
13 Display device
31 Image recognition unit
32 Composition determination unit
33 Region-of-interest determination unit
34 Motion information calculation unit
35 Deblurring unit
36 Image output unit

1. An image processing device comprising:
a composition determination unit that determines a composition in an image in accordance with a rule predetermined in a manner that depends on a subject;
a region-of-interest determination unit that determines a region of interest in a cropped image corresponding to the composition in the image; and
a motion information calculation unit that calculates motion information regarding motion of the subject predetermined in the region of interest.

2. The image processing device according to claim 1, further comprising a deblurring unit that executes a deblurring process on all of the cropped image in accordance with the motion information.

3. The image processing device according to claim 2, wherein
in a case where the subject in the cropped image is moving, the deblurring unit executes the deblurring process on all of the cropped image in accordance with the motion information to reduce blurring of the subject in the cropped image and increase blurring of a region other than the subject.

4. The image processing device according to claim 2, further comprising an image output unit that outputs the cropped image subjected to the deblurring process.

5. The image processing device according to claim 1, wherein
the region-of-interest determination unit determines the region of interest in accordance with the rule used when the composition is determined.

6. The image processing device according to claim 1, wherein
in a case where there is a plurality of the subjects that moves differently in the cropped image, the region-of-interest determination unit determines each of a plurality of the subjects as the region of interest.

7. The image processing device according to claim 6, wherein
in a case where a plurality of the regions of interest is determined in the cropped image, the motion information calculation unit calculates a value obtained by averaging pieces of the motion information regarding a plurality of the regions of interest as the motion information regarding the cropped image.

8. The image processing device according to claim 6, wherein
in a case where a plurality of the regions of interest is determined in the cropped image, the motion information calculation unit calculates a value obtained by giving predetermined weights to and adding up pieces of the motion information regarding a plurality of the regions of interest as the motion information regarding the cropped image.

9. The image processing device according to claim 1, further comprising an image recognition unit that executes an image recognition process of recognizing the subject from the image.

10. The image processing device according to claim 9, wherein
the composition determination unit determines the composition on a basis of a result of the image recognition process.

11. The image processing device according to claim 9, wherein
the composition determination unit determines a number of the compositions on a basis of a result of the image recognition process.

12. The image processing device according to claim 1, wherein
the composition determination unit determines the composition on a basis of a rule specified by a user.

13. The image processing device according to claim 1, wherein
the composition determination unit determines a number of the compositions specified by a user.

14. The image processing device according to claim 9, wherein
the composition determination unit is capable of switching between determination of the composition based on a result of the image recognition process and determination of the composition based on a rule specified by a user.

15. The image processing device according to claim 1, wherein
the composition determination unit determines a plurality of candidates for the composition in the image, causes a user to select one of the plurality of candidates determined, and finally determines the composition selected.

16. The image processing device according to claim 1, wherein
the region-of-interest determination unit determines a plurality of candidates for the region of interest in the cropped image, causes a user to select one of a plurality of the regions of interest determined, and finally determines the region of interest selected.

17. The image processing device according to claim 1, wherein
the image is captured by a fixed camera.

18. The image processing device according to claim 1, wherein
the image is captured by a PTZ camera.

19. An image processing method comprising:
determining a composition in an image in accordance with a rule predetermined in a manner that depends on a subject;
determining a region of interest in a cropped image corresponding to the composition in the image; and
calculating motion information regarding motion of the subject predetermined in the region of interest.

20. A program for causing a computer to execute processing, the processing comprising:
determining a composition in an image in accordance with a rule predetermined in a manner that depends on a subject;
determining a region of interest in a cropped image corresponding to the composition in the image; and
calculating motion information regarding motion of the subject predetermined in the region of interest.
